(19) United States
(12) Patent Application Publication
(10) Pub. No.: US 2014/0310351 A1
(43) Pub. Date: Oct. 16, 2014

(54) SYSTEM AND METHOD FOR SOCIAL NETWORKING BASED ON FAMILY RELATIONSHIPS

(71) Applicants: Damon Danielson, Santa Cruz, CA (US); Kevin Kalajan, Nevada City, CA (US)

(72) Inventors: Damon Danielson, Santa Cruz, CA (US); Kevin Kalajan, Nevada City, CA (US)

(21) Appl. No.: 13/862,364

(22) Filed: Apr. 12, 2013

(51) Int. Cl. H04L 29/06

(52) U.S. Cl. CPC H04L 65/403
USPC 709/204

(57) ABSTRACT

A system and method for social networking based on family relationships are disclosed. A particular embodiment includes: enabling a particular user to create, by use of a network connectable data processor, a family data structure that defines the family relationships between the particular user and his or her family members, the family data structure representing a core family group of the particular user; automatically sharing content among the family members in the core family group by use of the family data structure, the sharing of content including specifying as combination of attributes associated with the content and generating a shared content subset from the specified combination of attributes; and enabling, the particular user to create, by use of the network-connectable data processor, an invitation to invite another user to join the core family group based on a family relationship, the invitation identifying the other user by family role, label, or relationship, the invitation automatically including a photo from as shared core family group photo album.

### TECHNICAL FIELD

This patent application relates to computer-implemented software and networked systems, according to one embodiment, and more specifically to a system and method for social networking based on family relationships.

### COPYRIGHT

A portion of the disclosure, of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following, notice applies to the software and data as described below and in the drawings that form to part of this document: Copyright 2012-2013 KinCentral Inc., All Rights Reserved.

### BACKGROUND

Online social networking is widely used by users to make connections to new contacts and remain connected with their existing contacts. For example, a user may register for an account with an online social networking site, such as Facebook™, and post a profile on the site so that other users ma get to know him/her. The user may also post messages, photos, videos, or other files, on the site. The user may add other users on the same social networking site to his/her list of contacts, so that these contacts may view his/her posts on the site. For instance, the user may add people s/he knows in real life, such as his/her family members, relatives, and friends, to his/her list of contacts. Once a person is added as a contact, the user may be allowed to see the list of contacts of this person, and she may decide to add some of that person's contacts as his/her own contacts.

Given the large number of people to whom one could potentially connect on a social networking site the user's list of contacts can grow rapidly. Furthermore, it is common for a user to have several social networking accounts on different social networking sites. For example, one may have both a Facebook™ and a Linkedin™ account. With more networks, and more contacts per network, it becomes difficult to keep track of the networking content posted by all contacts, such as messages, articles, photos, videos, etc. In addition, because the contacts and networking content are maintained on the online sites, a user may not have a desired level of control over the privacy of the contacts and content. Further, many websites do not have robust and consistent support for mobile devices.

Smart phones have become the new camera of choice. An increasing percentage of all photos taken in the United States are taken by phones. Smart phones are becoming the predominant link between data and people. Additionally, data and information storage is changing. Network cloud data storage is becoming increasingly acceptable to consumers and is quickly becoming the data storage location of choice. However, large social networks are experiencing fatigue and consumers are looking for new ways to network while maintaining control over their privacy and the security of their data. In many cases, users may want to limit the scope of their social networks to the relationships that mean the most to them or the relationships that they are most likely to trust.

### BRIEF DESCRIPTION OF THE DRAWINGS

The various embodiments is illustrated by way of example, and not by way of limitation, in the figures of the accompanying drawings in which:

FIG. 1 illustrates an example embodiment of a social networking system based on family relationships;

FIG. 2 illustrates an example of a family data structure;

FIG. 3 illustrates an example embodiment, implemented as a mobile device app, that can be used to prompt the user to provide contact information for various family members;

FIG. 4 illustrates an example embodiment for supporting photo object tagging with an identification of family role, label, or relationship;

FIG. 5 illustrates an example embodiment, implemented as a web app, that can be used to prompt the user to invite a family member by family relationship;

FIG. 6 illustrates an example embodiment of an invitation personalized with family photos;

FIG. 7 illustrates another example embodiment of a networked system in which various embodiments may operate;

FIG. 8 is a processing flow chart illustrating an example embodiment of a method as described herein; and

FIG. 9 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for social networking based on family relationships are disclosed. The various embodiments provide the ability for improved social interaction between flintily members. In various embodiments, a software application program is used to enable the family-based social networking interface using a computer system, a web appliance, and/or a mobile device. As described in more detail below, the computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

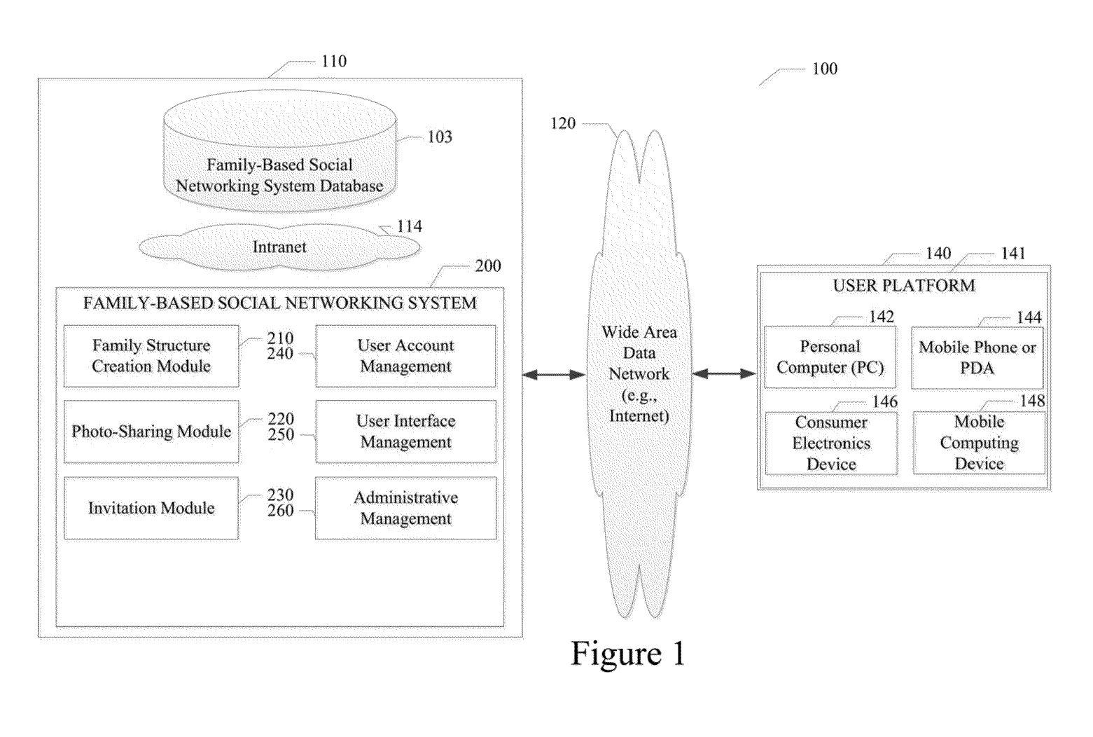

Referring now to FIG. 1, in an example embodiment, a system for family-based social networking on a network-enabled interface is disclosed. In various example embodiments, an application or service, typically provided by or operating on a host site (e.g., a website) 110, is provided to simplify and facilitate the downloading or hosted use of the family-based social networking system 200 of an example embodiment. In a particular embodiment, the family-based social networking system 200 can be downloaded from the host site 110 by a user at a user platform 140. Alternatively, the family-based social networking system 200 can be hosted by the host site 110 for a networked user at as user platform 140. The details of the family-based social networking system 200 of an example embodiment are provided below.

Referring again to FIG. 1, the family-based social networking system 200 can be in network communication with a plurality of user platforms 140. The host site 110 and user platforms 140 may communicate and transfer data and information in the data network ecosystem 100 shown in FIG. 1 via a wide area data network (e.g., the Internet) 120. Various components of the host site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof On an interconnected sot of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WEAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The family-based social networking system can be implemented using any form of network transportable digital data. The network transportable digital data can be transported in any of a group of file formats, protocols, and associated, mechanisms usable to enable a host site 110 and a user platform 140 to transfer data over a network 120. In one embodiment, the data format for the gift selection invitation interface can be HyperText Markup Language (HTML). HTML is a common markup language for creating web pages and other information that can be displayed in a web browser. In another embodiment, the data format for the gift selection invitation interface can be Extensible Markup Language (XML), XML is a markup language that defines a set of rules for encoding interfaces or documents in a format that is both human-readable and machine-readable. In another embodiment, as JSON (JavaScript Object Notation) format can be used to stream the interface content to the various user platform 140 devices, JSON is a text-based open standard designed for human-readable data interchange. The JSON format is often used for serializing and transmitting structured data over a network connection. JSON can be used in an embodiment to transmit data between a server, device, or application. wherein JSON serves as an alternative to XML.

In a particular embodiment, a user platform 140 with one or more client devices 141 enables a user to access data and provide data for the family-based social networking system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., Twitter), Multimedia Message Service (MMS), instant messaging (IM), internet relay chat (IRC), mIRC, Jabber, Enhanced Messaging Service (EMS), text messaging. Smart Messaging, Over the Air (OTA) messaging, or the like, between another computing device, and the like.

As one option, the family-based social networking system 200, or a portion thereof, can be downloaded to a user device 141 of user platform 140 and executed locally on a user device 141. The downloading of the family-based social networking system 200 application (or a portion thereof) can be accomplished using conventional software downloading functionality. As a second option, the family-based social networking system 200 can be hosted by the host site 110 and executed remotely, from the user's perspective, on host system 110. In one embodiment, the family-based social networking system 200 can be implemented as a service in a service-oriented architecture (SOA) or in a Software-as-a-Service (SAAS) architecture. In any case, the functionality performed by the family-based social networking system 200 is as described herein, whether the application is executed locally or remotely, relative to the user.

Referring again to FIG. 1, the family-based social networking system 200 of an example embodiment is shown to include a family-based social networking system database 103. The database 103 is used in an example embodiment for data storage of information related to the family relationships, communication between family members, document, photo, or communication sharing information, the users involved in the social interactions, and the control data for managing the social interactions. It will be apparent to those of ordinary skill in the art that the database 103 can be used for the storage of a variety of data in support of the family-based social networking system 200 of an example embodiment.

Referring again to FIG. 1, host site 110 of an example embodiment is shown to include a family-based social networking system 200. Family-based social networking system 200 can include a family structure creation module 210, a photo-sharing module 220, an invitation module 230, a user account management module 240, a user interface management module 250, and an administrative management module 260. Each of these modules can be implemented as software components executing within an executable environment of family-based social networking system 200 operating on host site 110 or user platform 140. Each of these modules of an example embodiment is described in more detail below in connection with the figures provided herein.

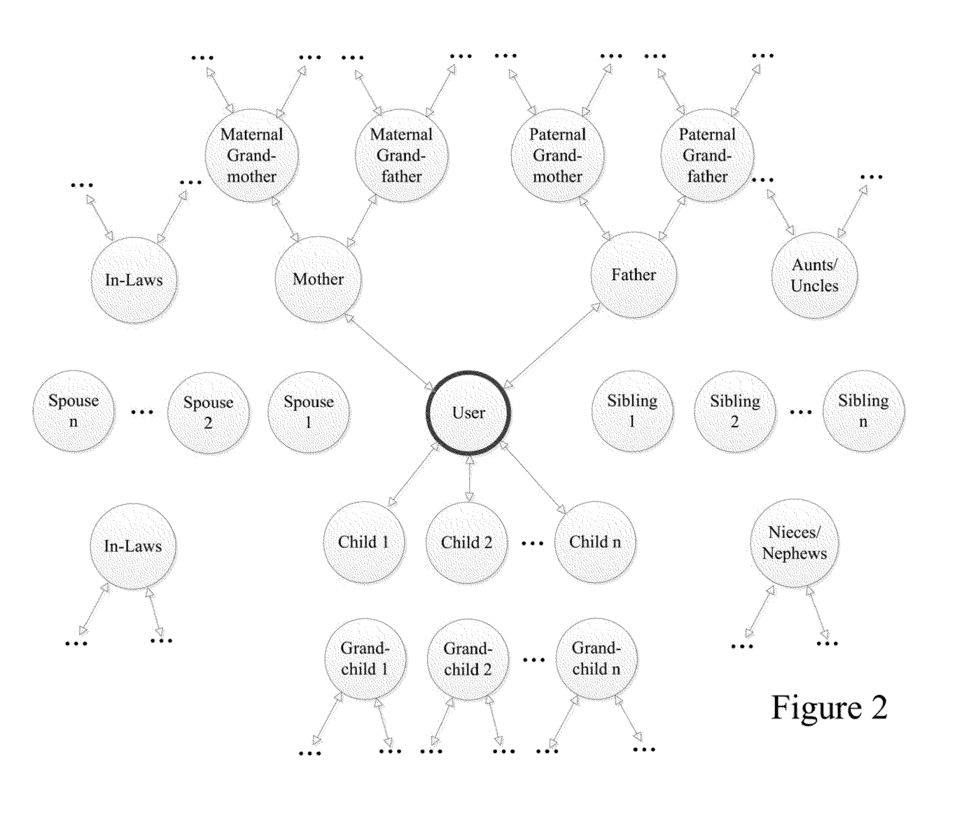

Referring to FIG. 1, the family-based social networking system 200 of an example embodiment can include a family structure creation module 210. The family structure creation module 210 is responsible for prompting a user provide information for creating a family data structure that defines the family relationships between the particular user and his or her family members. In one embodiment, the user can be prompted to provide contact information for various family members. The family structure creation module 210 is also responsible for generating and storing data structures that that define the family relationships between the particular user and his or her family members. An example of a family data structure is shown in FIG. 2, These family data structures can be stored in the system database 103.

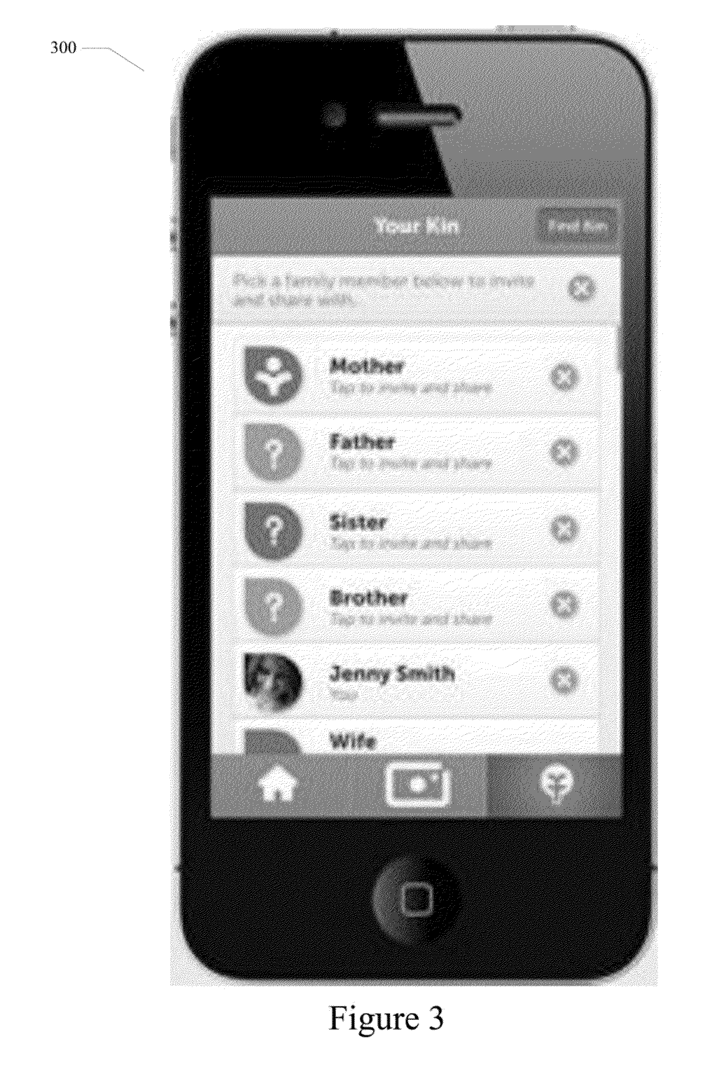

Referring now to FIG. 3, an example embodiment 300, implemented as a mobile device application (app) with the family structure creation module 210 therein, can be used to prompt the user to provide contact information for various family members. It will be apparent to those of ordinary skill in the art that other embodiments can also be implemented as a web application (apt)) with one or more webpages or other types of user interfaces. The contact information provided by the user can include the name, email address, telephone number, address, and other identifying information related to each family member. The contact information can also be used to send invitations or notifications to the family members as described in more detail below. In this manner, the user can be prompted to enter contact information for each of the family members the user chooses to define or specify. The particular contact or family member can be defined with a role, label, or relationship (e.g., father, sister, etc.) that defines the family member's place in the family structure. Because family relationships have a defined and deterministic logical structure, a corresponding data structure can be generated from the contact information provided by the user. For example, a particular embodiment can create a “core” family group of grandma, grandpa, mother, father, daughter, son, brother, sister in law, etc., because the family relationships and a particular person's place in the family structure can be inferred from the information provided by the user. Additionally, the particular embodiment can create menu items on a user interface that allow the user or family members to define additional or modified family structures, such as a family structure that includes a user's sister-in-law as part of a family with a second family built around her relationship with her family. Other family structures can be defined by the user, wherein the other family structures include only close family members (e.g., mother, father, siblings, husband, wife, and kids). Other family structures can be defined by the user, wherein the ether family structures include only blood-related family members (e.g., parents, siblings, kids, grandparents, etc.). Other family structures can be defined by the user, wherein the other family structures include in-law or blended family members (e.g., in-laws, step-kids, etc.). Other family structures can be defined by the user, wherein the other family structures include close friends, partners, godparents, and the like. In general, the example embodiment allows the user to create a variety of different family structures, each having a. defined structure and relationships between members. Additionally, different family data structures can be automatically joined or related if a particular family member is present in two (or more) different family data structures. The presence of a common family member in more than one family data structure can be determined based on a matching name, email address, or other profile attribute of the common family member. The example embodiments keep these relationships and associated data sharing privileges organized.

As part of the contact information provided by the user for each family member, the user can also define data sharing privileges or “Share settings” associated with each family member. For example, a particular family member can be configured by the user to not receive shared information and images that would otherwise be shared with all family members. In the example embodiment, whenever a family member is added by the user as a new contact as described above, the newly added family member is assigned by Family structure creation module 210 to the core family group and, as a result, the newly added family member is automatically configured to share information with all core family members “Share settings” allow users to control how documents, photos, and/or communications are shared among family members.

In the example embodiment, a contact list or address book including contact information can be imported into the family structure creation module 210 and used by the user to define the contact information for particular family members. Additionally, the family structure creation module 210 can be configured to access a defined set of social network sites to retrieve contact information from the profiles maintained on the social network sites. The user can provide the login credentials necessary to access the profiles maintained on the defined set of social network sites. For example, the user can configure the family structure creation module 210 to access a Facebook™ or Twitter™ account and obtain contact information maintained on those sites.

Referring again to FIG. 1, the family-based social networking system 200 of an example embodiment can include a photo-sharing module 220. The photo-sharing module 220 is responsible for managing the sharing of documents between family members. In the example embodiment, the shared documents can be image files, photos, text documents, video clips, audio dips, animations, graphics, media, or any other type of data network-transportable content. The family-based social networking system 200 of an example embodiment, and the photo-sharing module 220 therein, enables a fun, easy, private, and secure photo sharing platform for families.

The photo-sharing module 220 can store the shared documents for family collaboration and archiving in the network 120 cloud using conventional cloud technology. The family-based social networking system 200 of an example embodiment provides a fun and easy to use mobile and web platform that provides families with a private stream of pictures taken by any and all of the family members. For example, each picture taken, using a camera-enabled mobile device hosting a mobile app or each document or photo uploaded to the family-based social networking system 200), can be automatically sent to (or shared with) each family member's mobile device and/or computer screen, and additionally sent to the host 110 website, where the photos can be canned and archived by the family members. Because each family member has a particular place in the family data structure as described above, the photo-sharing module 220 can traverse the family data structure associated with the family member representing the source of the uploaded photo or document and automatically share the photo or document with other family members in the family data structure. Pictures (and other document files) from cameras, camera-enabled mobile devices, smartphones, and other sources can be uploaded and edited on the secure host 110 website as well. As a result, the example embodiment provides the ability to upload documents, photos, communications, and the like (e.g., content) to the host 110 website and organize and archive all family documents, photos, and communications (content) as a family unit. The example embodiment also provides robust family communication channels and group management. Again, because each family member has a particular place in the family data structure as described above, the photo-sharing module 220 can traverse the family data structure associated with the family member representing the source of a communication (e.g., a text message, email, or other content, from a family member) and automatically share the content with other family members in the family data structure. Family members can choose who is allowed to create and edit photo albums or who is allowed to send/receive communications. Family members can collaborate in creating photo albums or document sets. In the example embodiment, all photos, documents, or communications (content) captured from a family member in a family's shared mobile experience can be automatically transmitted to the host 110 website.

In an example embodiment, uploaded and subsequently shared content can be organized by several different viewing categorizations. Shared content can have a series of attributes, such as (but not limited to) who uploaded, when uploaded, who is tagged in the uploaded content, how uploaded (mobile vs. web-computer), size of uploaded content, number of views, number of likes, number of comments, recency of likes, recency of comments, recency of views, event to which the content relates, family to which the content relates, and the like. These attributes can be retained as meta data associated with the shared content. Hence, in one embodiment, the viewing user has the ability to elect viewing by any of the above combinations of parameters or attributes. The user, therefore, is enabled to view all photos, for example, from the event “Grandpa's Wedding” that were commented on in the past seven days, or photos having greater than ten comments, or photos having at least three “likes”, etc. Another example view that could be enabled for the use is a view of all photos that contain “my brother Nick” that were uploaded for the event “Nick's Graduation”. Again, because the various embodiments are aware of the family data structure associated with the family member(s) represented in the shared content, the views or queries on the shared content can be specified in terms of family relationships. Note that photos or other content originating from multiple albums and/or multiple families may contain content that is associated with a single event (or other related attribute). The various embodiments enable a user to see ALL photos (or content) from “Nick's Graduation” (or other related attribute) no matter who uploaded the photos and regardless of which photo album in which the photos were stored, as long as the photos were uploaded by an accessible family member. In addition, the various embodiments enable users to easily view the “best” photos from “Nick's Graduation” C by sorting on the most liked content attribute from a result list generated by a query for content related to “Nick's Graduation” for other related attribute). As a result, the various embodiments provide the ability to query and subset the enormous amount of potential uploaded content by selection criteria (e.g.., selected attributes) that aid in filtering out otherwise banal or unwanted content.

In another embodiment, the “views” or queries described above can be saved and shared. The user can bookmark or save the view to reference it at a later date and time. The saved view or query is automatically updated to reflect any dynamic changes to the underlying content. For example, if a new family member uploaded 100 new photos for the event “Nick's Graduation” (or other related attribute) and many of the photos were liked (as specified by the “like” attribute), some or all of these new photos would he automatically included in the users saved view. In another embodiment, the user may choose to he notified of changes to the saved view. such as described above. In yet another embodiment, the user may choose to share the saved “view” with other family members. For example, a user can share a saved “view” by sending a message to a family member that says, “Here are the BEST photos from Ted's Wedding!” The message can include a link to the sharing user's saved “view” and the resulting shared content subset provided to the family member stems from the combination of aforementioned criteria or attributes assembled by the sharing user.

Family members (users) own and control all of their own photos, documents, or communications, in one embodiment, the host 110 website does not monetize or distribute family photos or any of the family member's data. The various embodiments described herein are the only photo-sharing mobile and web platforms on the market that organize their data structures in a manner corresponding to a family structure, which thereby optimizes communications and document sharing between family members.

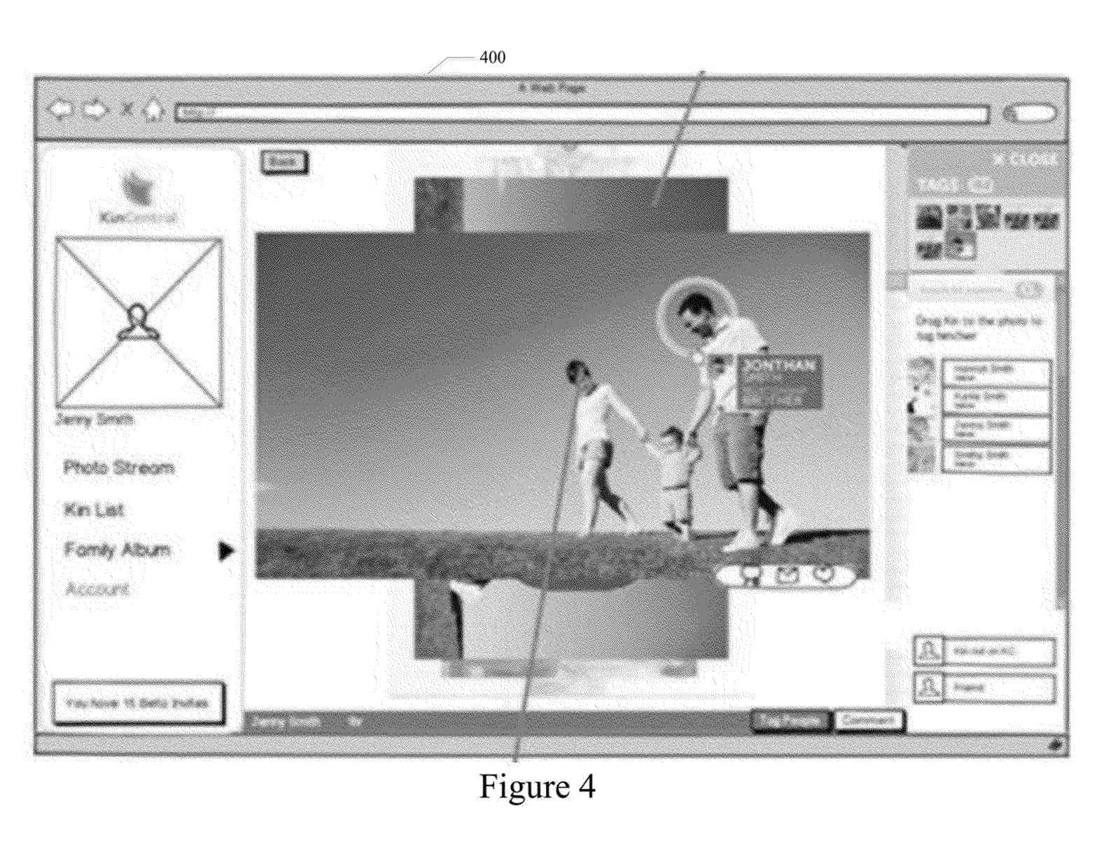

Referring now to FIG. 4, the photo-sharing module 220 can also support photo object tagging with an identification of family role, label, or relationship. As shown in FIG. 4, an example embodiment 400, implemented as a web app with the photo-sharing module 220 therein, can be used to prompt the user to identify objects in family photos and tag the objects with a name, identifier, or an identification of family role, label, or relationship. As a result, an identification tag is added to the photo with an indication of the object in the photo to which the identification tag applies. In this manner, a family member can tag objects in family photos with an identification of family role, label, or relationship of the people shown in the photos. These tagged photos can then be shared among the members of the core family group as described above. Because each family member has a particular place in the family data structure and the interrelationships between family members is known as described above, the identification of family role, label, or relationship listed in the identification tags can be modified to reflect the appropriate family role, label, or relationship of the family member receiving the tagged photo. For example, a tagged photo may identify a person in the photo as Jonathan Smith (Brother) because Jonathan Smith's brother tagged the photo that way (e.g., see FIG. 4). However, if this tagged photo is shared with the parents of Jonathan Smith, the identification tag on the shared photo can be automatically modified to identify the person in the photo as Jonathan Smith (Son). Thus, the example embodiments modify the identification tags to reflect the correct family relationships.

In the example embodiment described herein, as family member can create a profile page on a particular identified family member. Profile pages are shared with other family members and include only photos, documents, or communications added by the profiled person. In this manner, shared content can be constrained to only content added by the profiled person.

Referring again to FIG. 1, the family-based social networking system 200 of an example embodiment can include an invitation module 230. The invitation module 230 is responsible for enabling people to invite family members by family relationship. In this way, the invitees can be automatically added to the family data structure at the appropriate position. Whenever an invited family member is added, the new family member can he assigned to the core family group and new family member can begin to automatically share photos, documents, or communications with all other core family members.

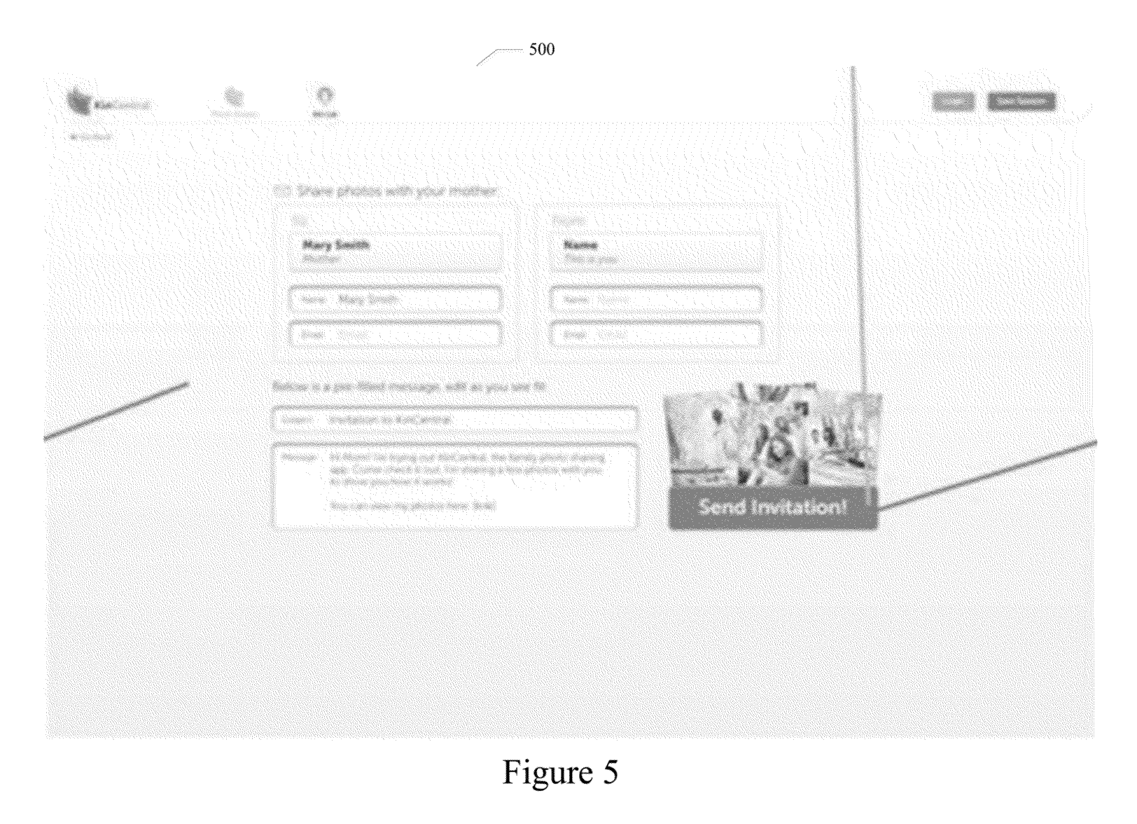

Referring now to FIG. 5, an example embodiment 500, implemented as a web app with the invitation module 230 therein, can be used to prompt the user to invite a family member by family relationship. In the example shown, a user is creating an invitation to invite his/her mother (or any other family member identified by family role, label, or relationship) to join the core family group. The invitation can be created from a standard template generated by the invitation module 230. As part of the creation of the invitation, the inviting family member (inviter) is prompted to identify the family member (by family role, label, or relationship) to whom the invitation will be directed (invitee). The inviting, family member is also prompted to enter a message for the invitee. The invitations can he created using either a web app or a mobile app.

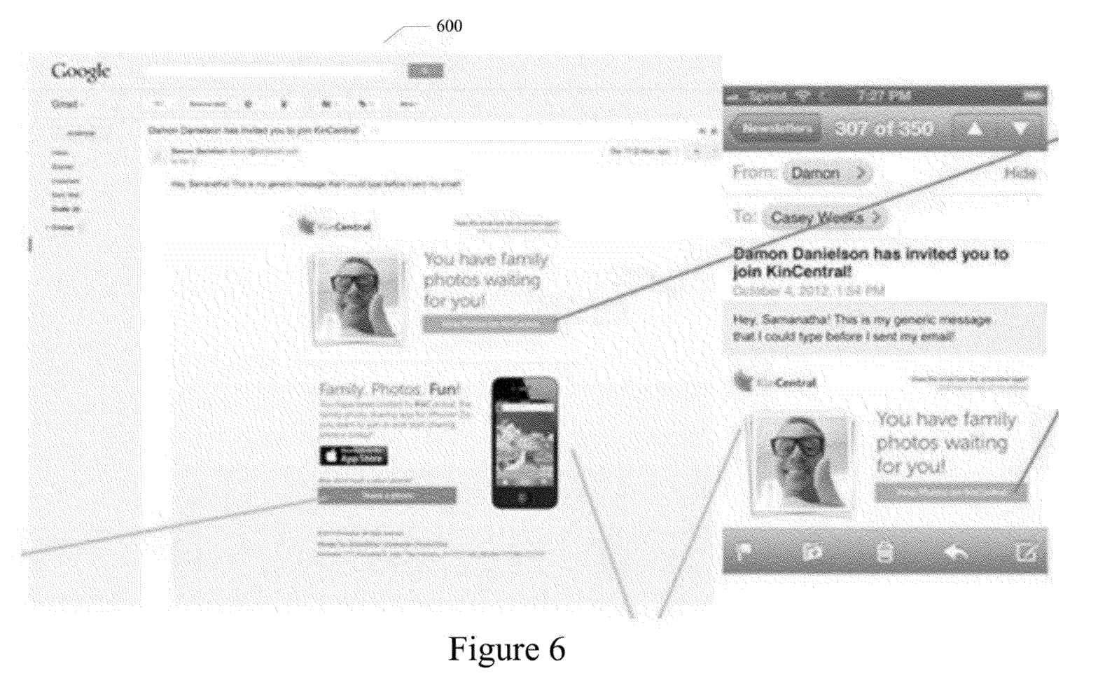

In the example embodiment, the invitation module 230 can insert one or more family photos into the invitation. Because the family relationship between the inviter and the invitee is known, the invitation module 230 can automatically access the shared photos maintained on the host site 110 for the corresponding core family group. The invitation module 230 can pull one or more photos from the core family group shared photos (e.g., the core family group photo album) and insert the one or more photos into the invitation. An example 600 of an invitation personalized with family photos is shown tear an example embodiment in FIG. 6. As a result, the invitee receives an invitation from a family member (inviter) whom the invitee knows with one or more photos the invitee may well recognize. This personalized invitation should lead to higher open rates and better security related to the photos, documents, and/or communications shared among family members. Once the invitation is created as described above, the invitation can be transferred to the invitee using standard data network communication processes (e.g., email, text message, etc.). Once the invitee receives the invitation and accepts the invitation to join the core family group, the invitation module 230 adds the invitee to the family data structure and configures the invitee to receive shared photos, documents, and communications from other family members.

In the example embodiment, an invitee receiving an invitation from another family member can use a standard app stare to download an app (either web or mobile) to respond to the invitation and to receive shared photos, documents, and communications from other family members. The invitation also enables the invitee to determine who originated the invitation. Users can invite multiple invitees simultaneously. Inviting users can also assign family attributes to an invitee (e.g., a family relationship, gender, step, in-law, etc.), Invitations can be sent to an invitee as an email message, a text message, or any other standard form of network communication. In the example embodiment, the system can default to one or more modes of communication.

Referring again to FIG. 1, the family-based social networking system 200 of an example embodiment is also shown to include a user account management module 240. The user account management module 240 can be used to create and maintain a user account on the host site 110. The user account management module 240 can also be used to configure user settings, create and maintain a user/user profile on host site 110, and otherwise manage user data and operational parameters on host site 110. In the example embodiment described herein, anonymous use is allowed. In the example embodiment, a user can try out the system, but remain anonymous. In this case, the user does not have to register and identify himself/herself. The user can also register as an anonymous user. When a user uses the system as an anonymous user, the family-based social networking system 200 of an example embodiment can save their photos, documents, communications, and family relationship information. However, in the example embodiment, the user must register as an identified user in order to share photos, documents, or communications. The registered user can enter their email address and their family relationship and/or name. Once this information is entered, the user can share photos, documents, and/or communications.

Referring again to FIG. 1, the family-based social networking system 200 of an example embodiment is shown to include a user interface management module 250. The user interface management module 250 handles the presentation of various user interface displays, display screens, windows, frames, or the like. In one embodiment, the user interface can be implemented as a series of web pages. In another embodiment, the user interface can be implemented as a series display screens on a mobile device as implemented by a mobile application or app in yet another embodiment, the user interface can be implemented as a series of voice command responses implemented using conventional voice recognition and voice synthesis technology on a mobile device as implemented by a mobile application or app. These various user interface displays are provided to present information, user prompts, invitations, notifications, photos, documents, and/or communications to a user of the family-based social networking system 200 of an example embodiment. The user interface management module 250 also receives user inputs and configures the various user interface displays in conformity with the user inputs, command selections, and the like.

Although the various user interface displays provided by the user interface management module 250 are nearly infinitely varied, several sample user interface displays and sequences are provided herein and in the corresponding figures to describe various features of the disclosed embodiments. These sample user interface displays and sequences are described above.

Referring again to FIG. 1, the family-based social networking system 200 of an example embodiment is shown to include an administrative management module 260. The administrative management module 260 can be used by an agent of the family-based social networking system 200 to manage user accounts and to manage the family-based social networking system.

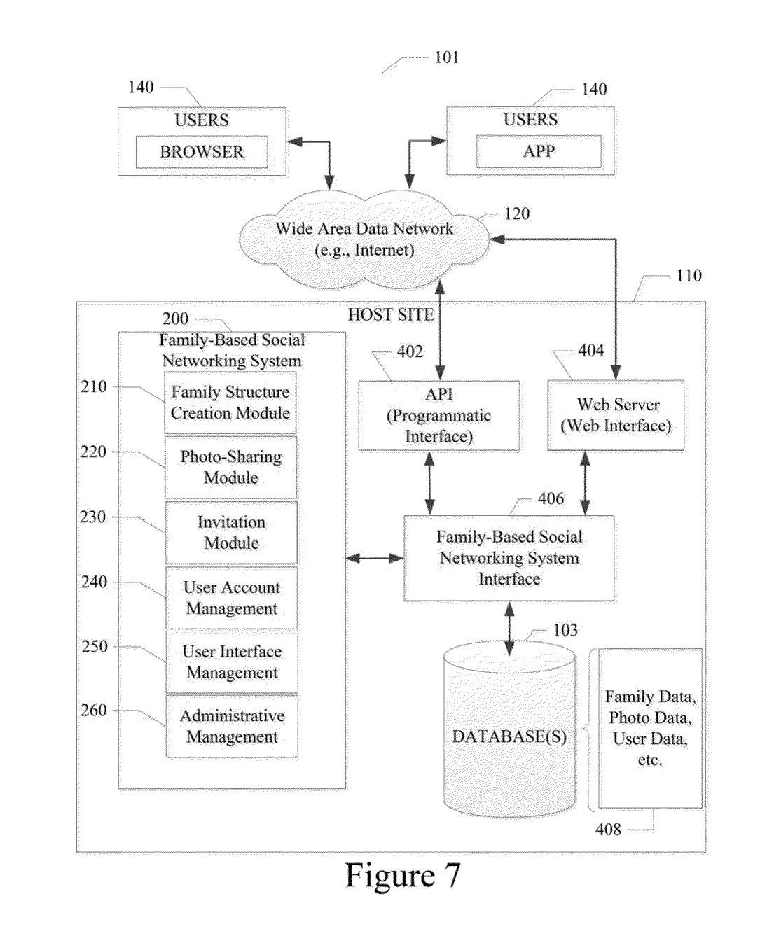

Referring now to FIG. 7, another example embodiment 101 of a networked system in which various embodiments may operate is illustrated. in the embodiment illustrated, the host site 110 is shown to include the family-based social networking system 200. The family-based social networking system 200 is shown to include the functional components 210 through 260, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic. or automated data transfer level. The API 402 and web interface 404 may he configured to interact with the family-based social networking system 200 either directly or via an interface 406. The family-based social networking system 200 may be configured to access a data storage device 103 and data 408 therein either directly or via the interface 406.

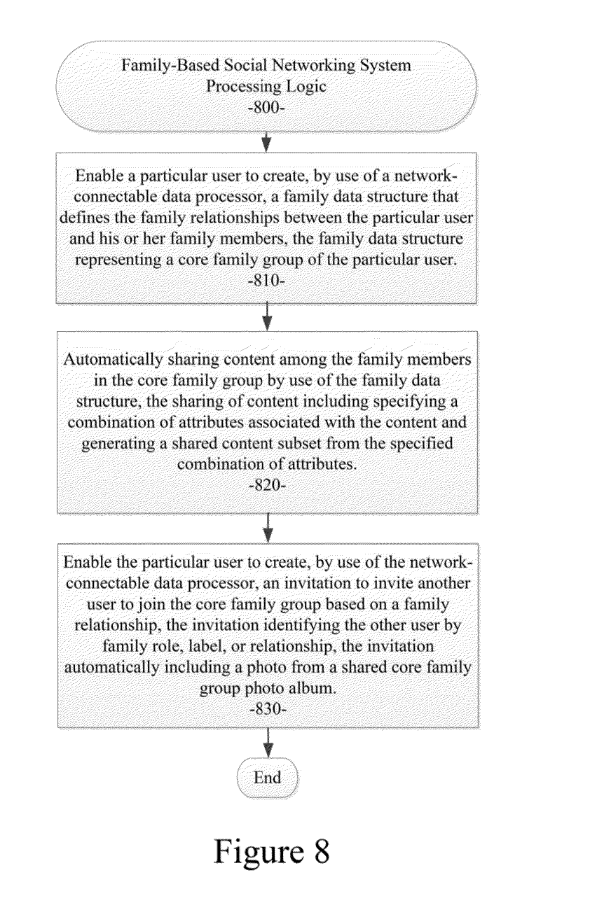

Referring now to FIG. 8, a processing flow diagram illustrates an example embodiment of a family-based social networking system 200 as described, herein. The method 800 of an example embodiment includes: enabling a particular user to create, by use of a network-connectable data processor, a family data structure that defines the family relationships between the particular user and his or her family members, the family data structure representing as core family group of the particular user (processing block 810); automatically sharing content among the family members in the core family group by use of the family data structure, the sharing of content including specifying a combination of attributes associated with the content and generating a shared content subset from the specified combination of attributes (processing block 820); and enabling the particular user to create, by use of the network-connectable data processor, an invitation to invite another user to join the core family group based on a family relationship, the invitation identifying the other user by family role, label, or relationship, the invitation automatically including a photo from a shared core family group photo album (processing block 830).

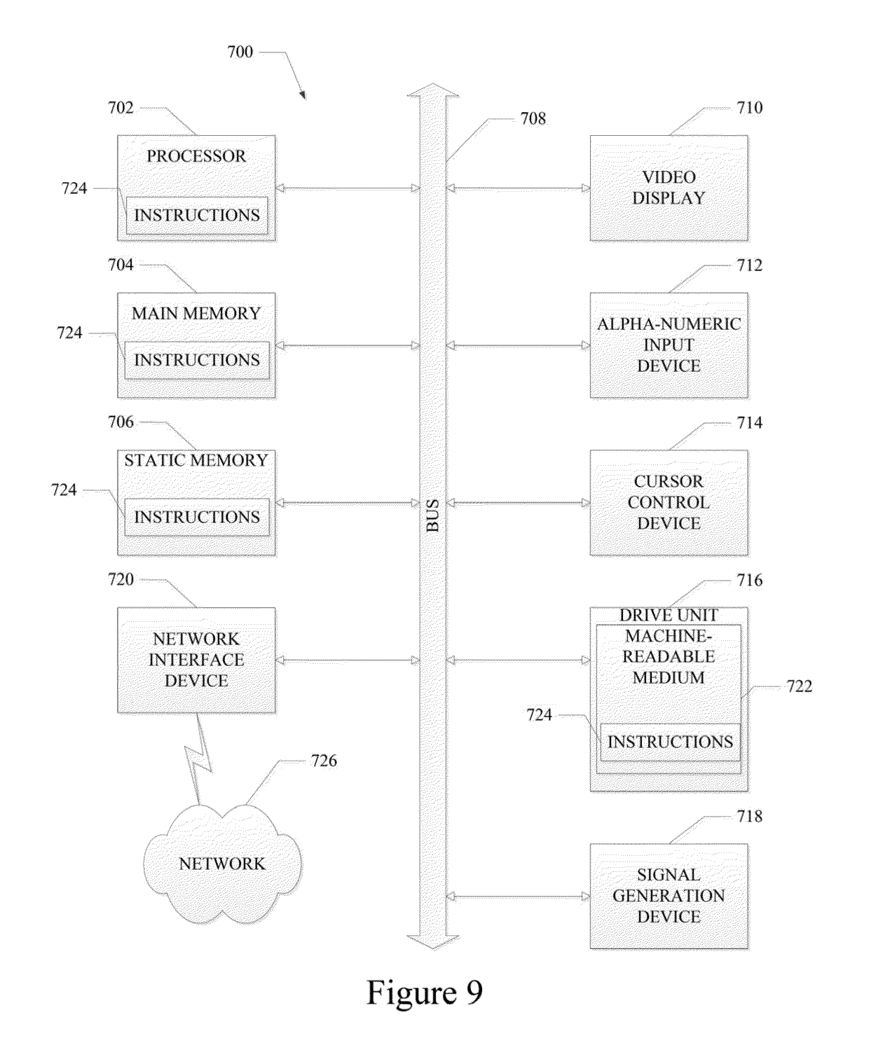

FIG. 9 shows to diagrammatic representation of a machine in the example form of a computer system 700 within which a set of instructions when executed may cause the machine to perform any one or more of the methodologies discussed herein. In alternative embodiments, the machine operates as a standalone device or ma he connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing as set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple non-transitory media (e.g., a centralized or distributed database, and/or associated caches and servers) that store the one or more sets of instructions. The term “machine-readable medium” can also he taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
enabling a particular user to create, by use of a network-connectable data processor, a family data structure that defines the family relationships between the particular user and his or her family members, the family data structure representing a core family group of the particular user;
automatically sharing content among the family members in the core family group by use of the family data structure, the sharing of content including specifying a combination of attributes associated with the content and generating a shared content subset from the specified combination of attributes; and
enabling the particular user to create, by use of the network-connectable data processor, an invitation to invite another user to join the core family group based on as family relationship, the invitation identifying the other user by family role, label, or relationship, the invitation automatically including a photo from a shared core family group photo album.

2. The method as claimed in claim 1 further including enabling the particular user to tag, by use of the network-connectable data processor, an object in it shared photo with an identification tag, the identification tag identifying a family role, label, or relationship of the object to the particular user.

3. The method as claimed in claim 1 further including prompting the particular user to provide information for creating the family data structure.

4. The method as claimed in claim 1 further including prompting the particular user to provide contact information for a family member of the core family group.

5. The method as claimed in claim 1 further including automatically placing information corresponding to a family member of the core family group into an appropriate location in the family data structure based on the family member's family relationship.

6. The method as claimed in claim 1 further including enabling the particular user to create more than one family structure.

7. The method as claimed in claim 1 further including enabling the particular user to define data sharing privileges or “Share settings” associated with each family member.

8. The method as claimed in claim 1 further including automatically sharing documents, photos, or communications among the family members in the core family group by use of the family data structure when any family member of the core family group uploads a document or photo to a host system.

9. The method as claimed in claim 1 further including enabling the particular user to create a profile page on a particular identified family member of the core family group.

10. A system comprising:
a data processor;
a network interface, in data communication with the data processor, for communication on a data network; and
a social networking system based on family relationships, executable by the data processor, to:
enable a particular user to create, by use of the data processor, a family data structure that defines the family relationships between the particular user and his or her family members, the family data structure representing a core family group of the particular user;
automatically share content among, the family members in the core family group by use of the family data structure, the social networking system being further configured to share content including specifying a combination of attributes associated with the content and generating a shared content subset from the specified combination of attributes; and
enable the particular user to create, by use of the data processor, an invitation to invite another user to join the core family group based on as family relationship, the invitation identifying the other user by family role, label, or relationship, the invitation automatically including a photo from a shared core family group photo album.

11. The system as claimed in claim 10 being further configured to enable the particular user to tag, by use of the network-connectable data processor, an object in a shared photo with an identification tag, the identification tag identifying a family role, label, or relationship of the object to the particular user.

12. The system as claimed in claim 10 being further configured to prompt the particular user to provide information for creating the family data structure.

13. The system as claimed in claim 10 being further configured to prompt the particular user to provide contact information for as family member of the core family group.

14. The system as claimed in claim 10 being further configured to automatically place information corresponding to a family member of the core family group into an appropriate location in the family data structure based on the family member's family relationship.

15. The system as claimed in claim 10 being further configured to enable the particular user to create more than one family structure.

16. The system as claimed in claim 10 being further configured to enable the particular user to define data sharing privileges or “Share settings” associated with each family member.

17. The system as claimed in claim 10 being further configured to automatically share documents, photos, or communications among the family members in the core family group by use of the family data structure when any family member of the core family group uploads a document or photo to a host system.

18. The system as claimed in claim 10 being further configured to enable the particular user to create a profile page on a particular identified family member of the core family group.

19. A non-transitory machine-useable storage medium embodying instructions which, when executed by a machine, cause the machine to:
enable s particular user to create, by use of the data processor, a family data structure that defines the family relationships between the particular user and his or her family members, the family data structure representing a core family group of the particular user;
automatically share content among the family members in the core family group by use of the family data structure, the sharing of content including specifying a combination of attributes associated with the content and generating a shared content subset from the specified combination of attributes; and
enable the particular user to create, by use of the data processor, an invitation to invite another user to join the core family group based on a family relationship, the invitation identifying the other user by family role, label, or relationship, the invitation automatically including a photo from a shared core family group photo album.

20. The non-transitory machine-useable storage medium as claimed in claim 19 being further configured to enable the particular user to tag, by use of the network-connectable data processor, an object in a shared photo with an identification tag, the identification tag identifying a family role, label, or relationship of the object to the particular user.
